(19) United States
(12) Patent Application Publication
(10) Pub. No.: US 2025/0121803 A1
(43) Pub. Date: Apr. 17, 2025

(54) DRIVER SIDE BRAKE CONTROLLER

(71) Applicant: Driving Success, Inc., Albuquerque, NM (US)

(72) Inventor: DAVID WYETT MCGINNIS, Albuquerque, NM (US)

(73) Assignee: Driving Success, Inc., Albuquerque, NM (US)

(21) Appl. No.: 18/818,437

(22) Filed: Aug. 28, 2024

Related U.S. Application Data
(63) Continuation of application No. 29/796,881, filed on Jun. 28, 2021.
Application No. 29/796,881 is a continuation of application No. 16/924,612, filed on Jul. 9, 2020, now Pat. No. 11,279,328.
(60) Provisional application No. 63/018,325, filed on Apr. 30, 2020.

(51) Int. Cl. B60T 7/10; B60T 7/06; B60T 17/20; G05G 1/54

(52) U.S. Cl. CPC B60T 7/102; B60T 17/20; G05G 1/54; B60T 7/06

(57) ABSTRACT

A driver side brake controller can include a telescoping shaft including a brake lever connector disposed thereon and adapted to be secured to a brake lever of a motor vehicle. A tubular main body can be provided that is adapted to adjustably accept the second telescoping end of the telescoping shaft therein and secure the telescoping shaft with locking hardware at a fixed position within the tubular main body to enable the main body to extend from the driver-side front floorboard area up into the driver side compartment near a steering wheel and within reach of a driver's hands. The tubular main body can terminate at a handle area that can be padded. The tubular main body can be rotated 360 degrees to allow for either hand (left, right) operation. Rotation can be facilitated by a swivel joint connecting the telescoping shaft and the brake lever connector.

### INVENTION PRIORITY

The present patent application claims priority as a continuation-in-part application of U.S. Design application Ser. No. 29/796,881, filed Jun. 28, 2021, entitled “Passenger Side Driving Instructor Brake Controller”, which is a continuation of U.S. Non provisional application Ser. No. 16/924,612, filed Jul. 9, 2020, entitled “Passenger Side Driving Instructor Brake Controller”, which is a continuation of Provisional Patent Application No. 63/018,325, filed Apr. 30, 2020, entitled “Passenger Side Driving Instructor Brake Controller”, which are all incorporated herein by reference.

### FIELD OF THE EMBODIMENTS

The present embodiments generally relate to braking assist devices. More particularly, the embodiments relate to systems and methods for providing a driver side brake controller for use by individuals missing a limb or suffering from sensitivity issues in their lower legs such as Neuropathy. The embodiments are also related to a driver side brake controller that is universal in that it can be adapted for use in various makes and models of automobiles, for both right-a left-driver configuration depending on country of use.

### BACKGROUND

When operating a motor vehicle, it is important to have control over its steering wheel and its brake to assure its safe operation. In the event of an emergency situation on a roadway, a driver will normally maneuver a motor vehicle by the steering wheel while slowing it down and stopping it once it is a position where it is safe along a roadside. Under most circumstance, only the driver can control both the steering wheel and brake of an automobile. Lack of brake control is not typically an issue during operation of a motor vehicle when the driver is experienced, but it can be problematic when an inexperienced driver undergoing driver training is involved, or a driver with medical issues or missing a limb are involved. Lack of brake control can result in a very dangerous, deadly outcome.

There are many individuals suffering from neuropathy, which affects feeling in a person's extremities such as their legs and feet. Neuropathy can sometimes be brought on because of the existence of an underlying condition such as diabetes. Yet many diabetics suffering from neuropathy must still drive. In many cases, individuals suffering from neuropathy have difficulty feeling the brake pedal on their automobile. There are also many individuals that may lose a limb, such as their right leg, thereby limiting their ability to drive a vehicle without modifications. Modifications can often be expensive and are typically only installed in the diver's personal vehicle. Should a person without a limb, or with neuropathy, want to rent a vehicle, the rental would not have modification installed therein to accommodate the individual.

For the foregoing reasons, what is needed for present day are improved systems to assure the safety of drivers suffering from neuropathy or missing a limb, as well assuring the safety of others sharing the roadways with such drivers. What is also needed is that such systems can be easily installed so that it can be used in personal as well as rented or borrowed vehicles.

### SUMMARY OF EMBODIMENTS

The following summary is provided to facilitate an understanding of some of the innovative features unique to the disclosed embodiment and is not intended to be a full description. A full appreciation of the various aspects of the embodiments disclosed herein can be gained by taking the entire specification, claims, drawings, and abstract as a whole.

An aspect of the present embodiments is to provide systems and methods to assure safe driving can occur within automobiles in real world scenarios where a person operating the automobile may be suffering from neuropathy or may be missing a limb.

According to another aspect of the embodiments, a driver side brake controller is disclosed that includes a brake lever connector disposed at the end of a telescoping shaft adapted to be adjusted and secured within a main tubular body that is further configured to extend within the driver side of the motor vehicle under the steering where it can be held at a handle area where the main body terminates within reach of either hand of the driver.

In accordance with another aspect of the embodiments, a driver side brake controller including a telescoping shaft and having a first end and a second end can be provided that can include a brake lever connector disposed at the first end of a telescoping shaft adapted to be secured to a brake lever of a motor vehicle disposed within a driver-side front floorboard area of the motor vehicle, and a tubular main body bent near it's the first end for connection to the tubular main body configured to adjustably accept the second end of the telescoping shaft therein and secure the telescoping shaft with locking hardware at a fixed position within the tubular main body to enable the main body to extend under the steering wheel in the driver compartment area of the motor vehicle wherein the tubular main body is bent near the second end about 90 degrees into a handle area within reach of a driver's right and left hands.

In accordance with yet another feature of the embodiments, the handle area can include padding that can facilitate adequate gripping or grasping of the handle area by the driver to assert control over the brake lever of the motor vehicle.

In accordance with yet another feature of the embodiments, the tubular main body can be bent in additional locations along its mid-section as needed to best configure it to fit between the driver's leg area and the steering wheel in a manner that it does not interfere with either as the driver is sitting in the driver compartment area during operation of the automobile.

In accordance with yet another feature of the embodiments, the locking hardware of the main tubular housing can include at least one of an adjustable locking screw, lever knob or detent bottom mechanism that can be manipulated to adjustably secure the telescoping shaft at various fixed positions within (i.e., extending in or out in length from as indicated by arrows) the tubular main body.

In accordance with yet another feature of the embodiments, the telescoping shaft can be rotatably attached to a brake lever connector body associated with the brake lever connector via a swivel joint coupled to the brake lever connector body. The swivel joint can enable 360-degree rotation of the telescoping shaft relative to the brake lever connector body and brake lever connector and further supports universal use of the brake controller in right- and left-driver configured motor vehicles.

In accordance with yet another feature of the embodiments, the brake lever connector can be configured in the shape of a C-clamp with an opening wide enough to accept brake levers of multiple makes and models of motor vehicles and can also include a knob fixed to a tightening screw. The knob fixed to a tightening screw associated with the brake lever connector can be tightened onto a brake lever once the opening of the brake lever connector is placed over the brake lever just above the brake pad.

In accordance with yet another feature of the embodiments, the tubular main body can be made from rigid materials such as steel and aluminum and is not easily bendable.

In accordance with yet another feature of the embodiments, the tubular main body can be hollow so that it can accept the telescoping shaft, which can also be made of rigid materials such as steel and aluminum and also should not be easily bent.

In accordance with yet another feature of the embodiments, the tubular main body can be coated with soft rubber or plastic coating that can help prevent damage to the console and other surfaces located within the motor vehicle. The coating can be provided in a variety of decorative finishes and colors.

### BRIEF DESCRIPTION OF THE FIGURES

The accompanying figures, in which like reference numerals refer to identical or functionally similar elements throughout the separate views and which are incorporated in and form a part of the specification, further illustrate the present invention and, together with the detailed description herein, serve to explain the principles of the disclosed embodiments.

FIG. 1A illustrates an exemplary side view layout of a driver side brake controller, in accordance with features of the embodiments.

FIG. 1B illustrates an exemplary handle end view for the layout of the driver side brake controller of FIG. 1A, in accordance with features of the embodiments.

FIG. 3 illustrates an exemplary side-by-side layout of a telescoping shaft and main tubular body, in accordance with features of the embodiments.

FIG. 4 illustrates a side view of a telescoping shaft and main tubular body interface point with locking hardware, in accordance with features of the embodiments.

FIG. 5 illustrates side view layout for details of the brake lever connector and associated hardware, in accordance with features of the embodiments.

FIG. 6 illustrates a bottom view of brake lever connector and associated hardware, in accordance with features of the embodiments.

FIG. 7 illustrates installation of the telescoping shaft of a driver side brake controller to a brake lever, in accordance with the embodiments.

FIG. 8 illustrates a driver side brake controller attached to a brake lever within a motor vehicle compartment from a driver door side view up towards the steering when in the driver compartment area of a motor vehicle, in accordance with the embodiments.

FIG. 9 illustrates a view from behind a dashboard area of a motor vehicle of a driver side brake controller installed onto a brake lever within a motor vehicle compartment from a driver door side view and extending upward into the driver compartment area of a motor vehicle where near the steering wheel where either the driver's right or left hands can grip the handle to manipulate the controller, in accordance with the embodiments.

FIG. 10A-10B illustrate views of exemplary positions of a driver's foot relative to a brake pedal in a motor vehicle while a driver side brake controller is connected to a brake lever of a motor vehicle just above the brake footpad, in accordance with the embodiments.

FIG. 11 illustrates a block diagram of method steps for using a driver side brake controller, in accordance with features of the embodiments.

FIG. 12 illustrates a block diagram of method steps for using a driver side brake controller, in accordance with features of the embodiments.

The particular values and configurations discussed in these non-limiting examples can be varied and are cited merely to illustrate at least one embodiment and are not intended to limit the scope thereof.

### DETAILED DESCRIPTION

The embodiments now will be described more fully hereinafter with reference to the accompanying drawings, in which illustrations are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the disclosed embodiments. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

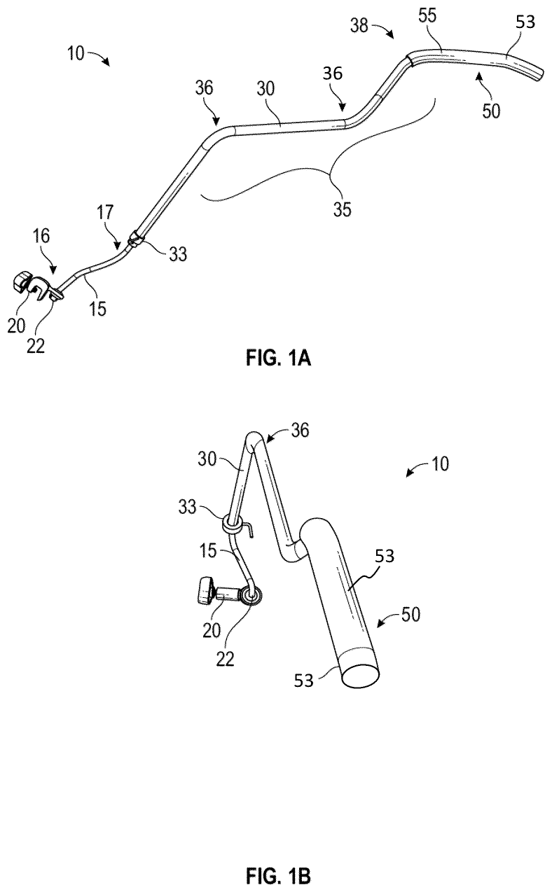

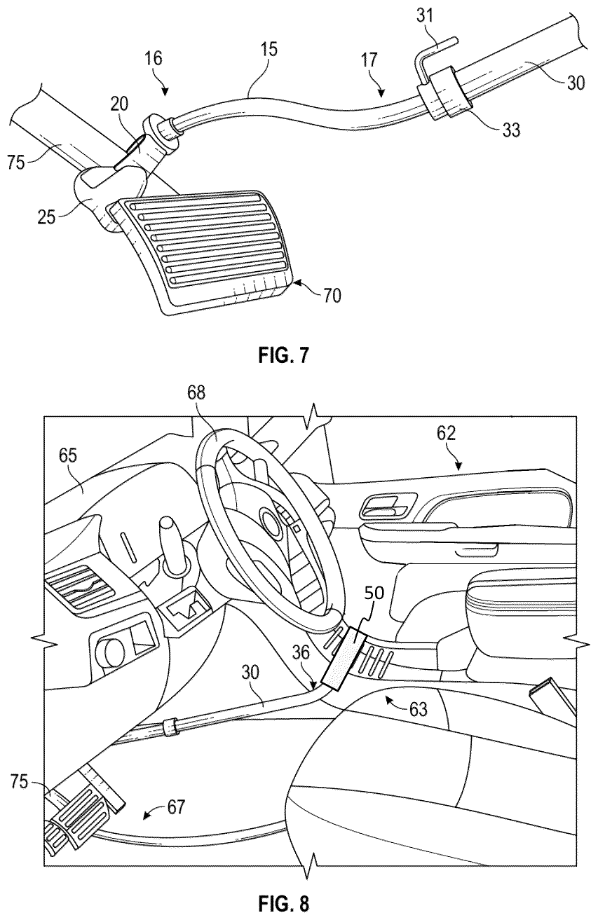

Referring to FIGS. 1A-1B, FIG. 7 and FIG. 8, illustrated is a layout of a driver side brake controller 10, in accordance with features of the embodiments. FIG. 1A illustrates a side view of the driver side brake controller 10 with arrows indicating a first telescoping end 16, second end 50 and mid-section 35 of the driver side brake controller 10, while FIG. 1B more specifically illustrates the second end 50 view of the passenger side driving instructor brake controller 10 that includes a handle area 53 that can include padding 55. The driver side brake controller 10 can include a telescoping shaft 15 including a first telescoping end 16 and a second telescoping shaft end 17. A brake lever connector 20 can be coupled at the first end 16 of a telescoping shaft 15 and can be adapted to be secured to a brake lever 75 (see FIG. 7) of a motor vehicle 65 (see FIG. 8) typically disposed within a driver-side front floorboard area 67 (FIG. 8) of the motor vehicle 65. A tubular main body 30 can have a mid-section 35 that can be bent 36 at least once to configure the tubular main body 30 to extend within the driver compartment 63 beneath the steering wheel 68 (FIG. 8) of the motor vehicle 65 while limiting or avoiding contract with legs of a driver that may be sitting in the driver compartment 63 while the driver is operating the motor vehicle 65.

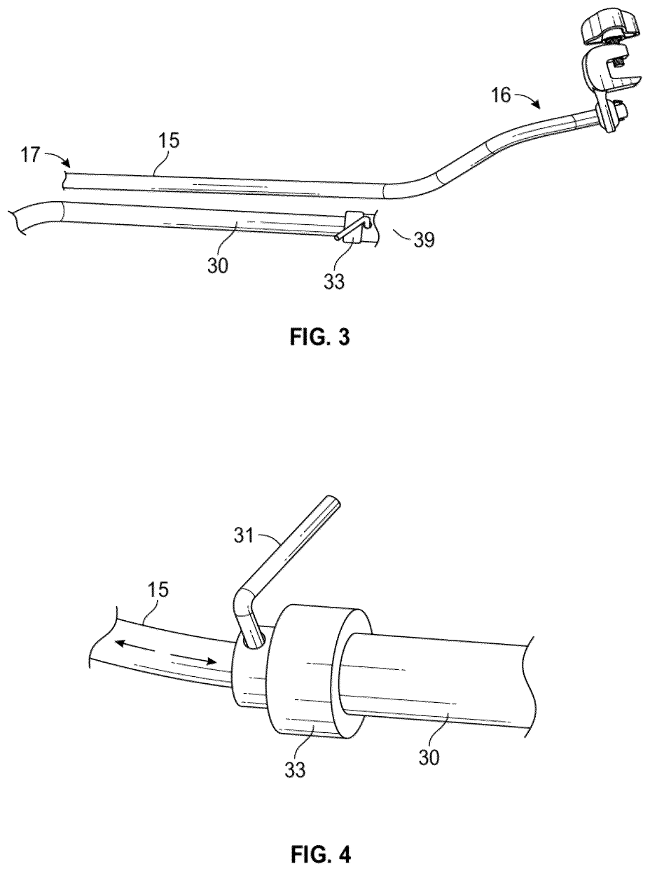

Referring to FIGS. 1A-1B, FIG. 3 and FIG. 4, the tubular main body 30 can be configured to adjustably accept the second telescoping end 17 of the telescoping shaft 15 within an opening 39 (see FIG. 3) formed in the tubular main body 30 and secure the telescoping shaft 15 at its second end with locking hardware 33 located at or near the opening 39 formed in the tubular main body 30. The locking hardware 33 can include, for example, an adjustable locking screw 31 as shown that can be tightened and loosened to adjustably secure the telescoping shaft 15 at various fixed positions within (i.e., extending in or out in length from as indicated by arrows) the tubular main body 30. It can be appreciated that the locking hardware 33 can be provided in different means or forms including as a lever, knob, detent button mechanism, etc. The locking hardware 33 can enable the tubular main body 30 to be adjusted relative to the telescoping shaft 15 to enable the tubular main body 30 to be universal as it can be rotated within the driver compartment 63 of a motor vehicle 65 in a manner that can prevent the mid-section 35 of the tubular main body 30 to interfere with a driver that may be in the driver compartment 63 during motor vehicle 65 operation. The tubular main body 30 can include enough length from where it is first bent 36 for it to extend upward and beneath the steering wheel 68 in the driver compartment area 63. The tubular main body 30 can then terminate at a handle area 50 located and the second end 50.

The handle area 50 can include padding 55 that can facilitate adequate gripping or grasping of the handle area 50 by a driver to assert control over the brake 70 with the driver side brake controller 10. The padding 55 can include soft rubber and foam products. The padding 55 will ideally assure that a driver can maintain a good grip on the handle during operation of a motor vehicle by a student driver. Ideally, the padding 55 will not be slippery. The tubular main body 33 can be made from rigid materials such as steel and aluminum and is not easily bendable. The tubular main body 33 is hollow so that it can accept the telescoping shaft 15, which can also be made of rigid materials such as steel and aluminum and also should not be easily bendable. The tubular main body 30 can be coated with soft rubber or plastic coating that can help prevent damage to the console and other surfaces located within the motor vehicle. The coating can be provided is a variety of decorative finishes and colors.

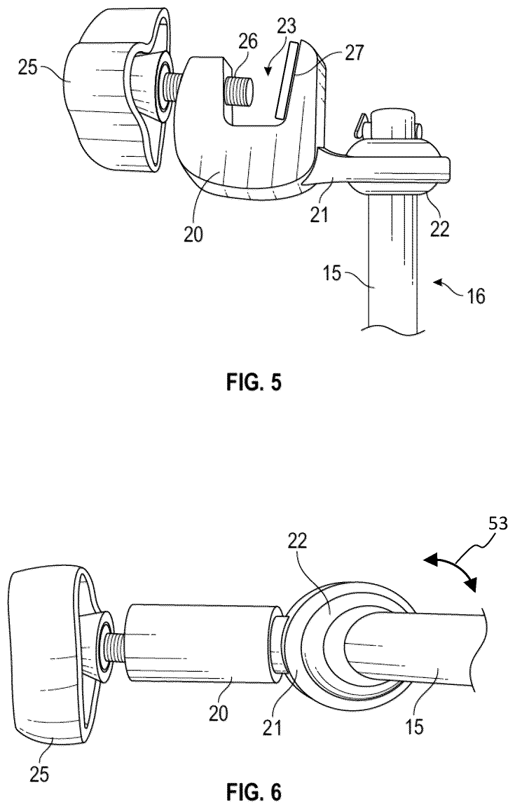

Referring to FIGS. 5-6, illustrated are details of the brake lever connector 20 and associated hardware, in accordance with the embodiments. Referring to FIG. 5, a side view is illustrated showing details of the brake lever connector 20 and associated hardware attached at the first telescoping end 16 of the telescoping shaft 15, in accordance with the embodiments. FIG. 6 illustrates a bottom view of the brake lever connector 20 where connection of the telescoping shaft 15 is shown in more detail. The telescoping shaft 15 can be rotatably attached to a brake lever connector body 21 associated with the brake lever connector 20 via a swivel joint 22 coupled to the brake lever connector body 21. The swivel joint 22 can enable 360-degree rotation of the telescoping shaft relative to the brake lever connector body 21 and brake lever connector 20, as indicated by arrows 29. The swivel joint 22 supports universal use of the driver side brake controller to enable right-handed and left-handed grip and manipulation by a driver of the motor vehicle 65. The brake lever connector can be configured in the shape of a C-clamp with an opening 23 wide enough to accept brake levers 75 of multiple makes and models of motor vehicles and can also include a knob 25 fixed to a tightening screw 26 to secure the brake lever connector 20 to a brake lever 75. It should be appreciated that other means of securing the brake lever connector can be utilized based on the present teaching. For example, straps, clamps and adhesives can be considered, but a tight connection to the brake lever must be assured and a knob-screw configuration is believed to provide the most secured connection of the brake lever connector 20 to a brake lever 75. Rubber coating 27 can be applied to at least the inner surface of the C-clamp to better adhere to the surface of a brake lever 75. Rubber coating can help prevent slipping or inadvertent removal of the brake lever connector 20 from brake levers 75.

Referring again to FIG. 7, installation of a driver side brake controller 10 to a brake lever 75 is illustrated in accordance with the embodiments. A knob 25 fixed to a tightening screw 26 associated with the brake lever connector 20 can be firmly tightened onto a brake lever 75 once the opening 23 of the brake lever connector 20 is placed over the brake lever 75 just above the brake pad 70. Placement above the brake pad 70 will ideally leave room for a driver's foot to comfortably fit over the brake pad 70. Placement at least two to six inches above the brake pad should accommodate most drivers.

Referring again to FIG. 8, illustrated is a driver side brake controller 10 installed onto a brake lever 75 within a motor vehicle 65, in accordance with features of the embodiments. As illustrated in FIG. 8, the tubular main body 30 can ideally extend well up into the driver compartment area 63 beneath the steering wheel 68 from a point where the tubular main body 30 is first bent 36 so that a driver can grab and control the driver side brake controller 10 with either the right or left hand. It should be appreciated that the passenger side driving instructor brake controller 10 can be universally used in either right- or left-driver vehicle configurations given the pivoting action of the brake lever connector 20 relative to the telescoping shaft 15 and tubular main body 30.

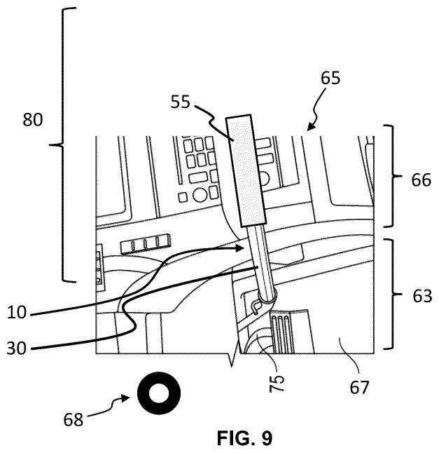

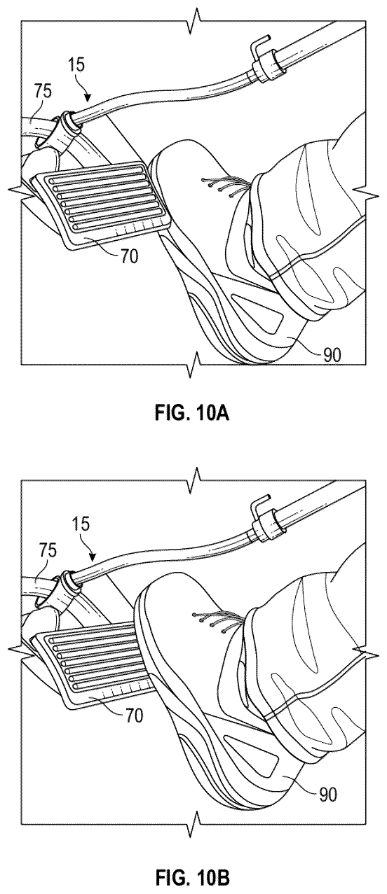

Referring to FIG. 9, illustrated is a view from behind a dashboard area 80 of a motor vehicle 65 with a driver side brake controller 10 installed onto a brake lever 75, in accordance with the embodiments. A perspective between the area for the steering wheel 68 and the center console 66 within driver compartment area 63 of a motor vehicle 65 are illustrated. The main tubular body 30 is shown extending from up it connection to the brake lever 75 in the driver-side front floorboard area 67 through the driver compartment area where the handle padding 55 of the handle area 50 can be gripped by a driver's hand (right hand location for handle is illustrated, but not intended to be limiting) wherefrom the driver can hold onto a padded handle 55 and manipulate/control the brake lever of the motor vehicle 65.

Referring to FIGS. 10A-B, illustrated are exemplary positions of a driver's foot 90 relative to a brake pedal while a driver side brake controller 10 is connected to the brake lever 75. Referring to FIG. 10A, a driver's foot 90 is shown off of the brake pedal 70 (presumably pressing on an accelerator). In FIGS. 10A-10B, the driver side brake controller 10 is located above the brake pad 70 in a manner that it does not interfere with the driver's foot 90. In FIG. 10A, the driver can press down on the brake with the driver side brake controller 10 if necessary while simultaneously controlling the steering wheel 68 with the driver's other hand. Referring to FIG. 10B, the driver's foot 90 is shown pressing on the brake pedal 70. From this standpoint, a driver can pull up on the brake pedal 70 should it become necessary to release or control pressure being applied to the brake pedal 70 by the driver's foot 90. A driver can also press down on the brake pedal 70 to provide further control, by hand, the slowing or stopping the motor vehicle 65.

It should now be appreciated that it is very useful that driver with foot-leg neuropathy, missing a limb, or having an artificial limb, can manipulate the brake pedal 70 with either of their hands using the driver side brake controller 10. Only one hand is required to manipulate the driver side brake controller 10, leaving the other hand free to simultaneously manipulate the steering wheel 68 during driving.

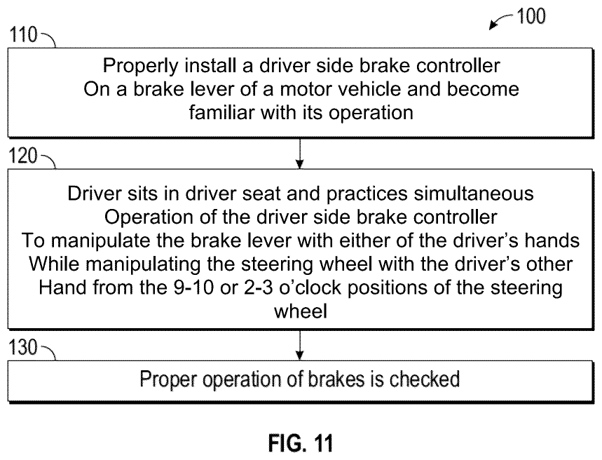

There are considerations a driver should undertake before first using a driver side brake controller 10 in a motor vehicle 65 on public roadways. Referring to FIG. 11, illustrated is a flow diagram 100 of a method for controlling a brake pedal 70 via connection of a driver side brake controller 10 to the brake lever 75 in preparation for gits general use, in accordance with features of the embodiments. As shown in Block 110, before utilizing the driver side brake controller 10 on public roads, it is first advisable that the driver properly install (or have properly installed) the driver side instructor brake controller 10 onto a brake lever 75 of a motor vehicle 65 and then become familiar with its operation on the motor vehicle 65. An initial test drive can ideally include another licensed driver sitting in the Passenger Seat of the vehicle 65. As shown in Block 120, the driver sits in the driver's seat and practices simultaneous operation of the driver side brake controller 10 to manipulate the brake pedal 70 with either hand and the steering wheel 68 with the driver's other hand firmly gripping the steering wheel 68 at either 10 o'clock or 2 o'clock positions, or at 9 o'clock and 3 o'clock positions, on the steering wheel, whichever is more comfortable and also depending on which hand was chosen to control the driver side brake controller 10. It is usually best to first practice in an empty parking lot or other location removed from the dangers and distractions of high traffic street driving areas. Proper operation of the brakes should be checked, as shown in block 130.

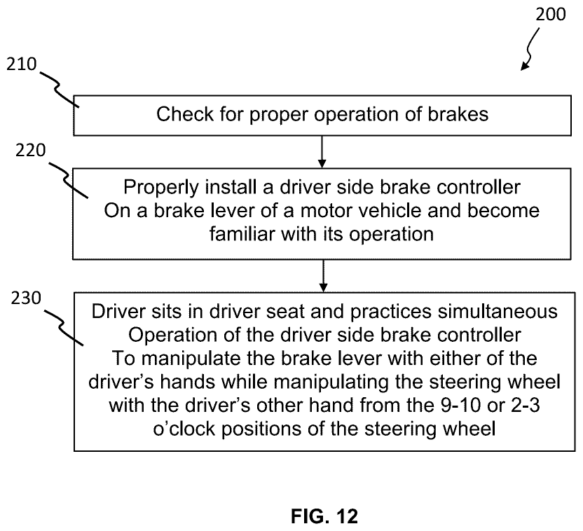

Referring to FIG. 12, illustrated is a flow diagram 200 of another method for controlling a brake pedal 70 via connection of a driver side brake controller 10 to the brake lever 75 in preparation for gits general use, in accordance with features of the embodiments. As shown in Block 210, Proper operation of the brakes on the motor vehicle 65 that will be used with the driver side brake controller 10 should first be checked. Then, as shown in Block 220, before utilizing the driver side brake controller 10 on public roads, it is first advisable that the driver properly install (or have properly installed) the driver side instructor brake controller 10 onto a brake lever 75 of a motor vehicle 65 and then become familiar with its operation on the motor vehicle 65. An initial test drive can ideally include another licensed driver sitting in the Passenger Seat of the vehicle 65. Then as shown in Block 230, the driver sits in the driver's seat and practices simultaneous operation of the driver side brake controller 10 to manipulate the brake pedal 70 with either hand and the steering wheel 68 with the driver's other hand firmly gripping the steering wheel 68 at either 10 o'clock or 2 o'clock positions, or at 9 o'clock and 3 o'clock positions, on the steering wheel, whichever is more comfortable and also depending on which hand was chosen to control the driver side brake controller 10. As mentioned before, it is usually best to first practice in an empty parking lot or other location removed from the dangers and distractions of high traffic street driving areas.

It will be appreciated that variations of the above-disclosed and other features and functions, or alternatives thereof, may be desirably combined into many other different systems or applications. It should also be appreciated that various presently unforeseen or unanticipated alternatives, modifications, variations or improvements therein may be subsequently made by those skilled in the art which are also intended to be encompassed by the following claims.

1. A driver side brake controller, comprising:
a telescoping shaft including a first end and a second end;
a brake lever connector disposed at the first end of a telescoping shaft and adapted to be secured to a brake lever of a motor vehicle disposed within a driver-side front floorboard area of the motor vehicle; and
a tubular main body having a mid-section and bent near its mid-section, the tubular main body configured to adjustably accept the second end of the telescoping shaft within the tubular main body and secure the telescoping shaft with locking hardware at a fixed position within the tubular main body to enable the main body to reach a steering wheel area in the motor vehicle where the tubular main body is bent the second end of tubular main body where it terminates at a handle area.

2. The driver side brake controller of claim 1, further comprising a swivel joint connecting the first end of the telescoping shaft and the brake lever connector, wherein the swivel joint enables the telescoping shaft and tubular main body to be manipulated 360 degrees with respect to the brake lever connector when the brake lever connector is connected to the brake lever.

3. The driver side brake controller of claim 1, wherein the brake lever connector further comprises a C-clamp with a tightening screw adapted to firmly grasp the brake lever above a brake pad associated with the brake lever.

4. The driver side brake controller of claim 1, wherein the handle area further comprises padded grip formed around the tubular main body at the handle area.

5. The driver side brake controller of claim 1, wherein the locking hardware further comprises a C-clamp including a screw that is adjustable to tightly and immovably secure the telescoping shaft within the tubular main body.

6. The driver side brake controller of claim 1, wherein the tubular main body is coated with rubber material.

7. The driver side brake controller of claim 1, further configured to enable a driver to pull back on the handle area as the driver applies foot pressure to the pedal to enable correction of the diver's foot action when the driver notices that the driver has inadvertently used too much brake or has stopped in a given situation while traveling on a roadway.

8. A driver side brake controller, comprising:
a telescoping shaft including a first end and a second end;
a brake lever connector disposed at the first end of a telescoping shaft and adapted to be secured to a brake lever of a motor vehicle disposed within a driver-side front floorboard area of the motor vehicle;
a swivel joint connecting the first end of the telescoping shaft and the brake lever connector, wherein the swivel joint enables the telescoping shaft and tubular main body to be manipulated 360 degrees with respect to the brake lever connector when the brake lever connector is connected to the brake lever; and
a tubular main body that is rubber coated and having a mid-section and bent near its mid-section, the tubular main body configured to adjustably accept the second end of the telescoping shaft within the tubular main body and secure the telescoping shaft with locking hardware at select positions within the tubular main body to enable the main body to extend within the driver compartment of the motor vehicle to a steering when area where the tubular main body is then bent at its second end of the tubular main body and terminates at a handle area.

9. The driver side brake controller of claim 8, wherein the brake lever connector further comprises a C-clamp with a tightening screw adapted to firmly grasp the brake lever above a brake pad associated with the brake lever.

10. The driver side brake controller of claim 8, wherein the handle area further comprises padded grip formed around the tubular main body at the handle area.

11. The driver side brake controller of claim 8, wherein the locking hardware further comprises a C-clamp including a screw that is adjustable to tightly and immovably secure the telescoping shaft within the tubular main body.

12. The driver side brake controller of claim 8, further configured to enable a driving instructor to pull back on the handle area as a student driver applies foot pressure to the pedal to enable correction of the student diver's action on the pedal.

13. The driver side brake controller of claim 8, further configured to enable a driving instructor to pull back on the handle area as a student driver applies foot pressure to the pedal to enable correction of the student diver's action when the instructor notices the student driver has inadvertently used too much brake or has stopped in a given situation while traveling on a roadway.

14. A driver side brake controller, comprising:
a telescoping shaft including a first end and a second end;
a brake lever connector disposed at the first end of a telescoping shaft and adapted to be secured to a brake lever of a motor vehicle disposed within a driver-side front floorboard area of the motor vehicle;
a tubular main body having a mid-section and bent near its mid-section, the tubular main body configured to adjustably accept the second end of the telescoping shaft within the tubular main body and secure the telescoping shaft with locking hardware at a fixed position within the tubular main body to enable the main body to reach a steering wheel area in the motor vehicle where the tubular main body is bent the second end of tubular main body where it terminates at a handle area; and
a swivel joint connecting the first end of the telescoping shaft and the brake lever connector, wherein the swivel joint enables the telescoping shaft and tubular main body to be manipulated 360 degrees with respect to the brake lever connector when the brake lever connector is connected to the brake lever.

15. The driver side brake controller of claim 14, wherein the brake lever connector further comprises a C-clamp with a tightening screw adapted to firmly grasp the brake lever above a brake pad associated with the brake lever.

16. The driver side brake controller of claim 14, wherein the handle area further comprises padded grip formed around the tubular main body at the handle area.

17. The driver side brake controller of claim 14, wherein the locking hardware further comprises a C-clamp including a screw that is adjustable to tightly and immovably secure the telescoping shaft within the tubular main body.

18. The driver side brake controller of claim 14, wherein the tubular main body is coated with rubber material.

19. The driver side brake controller of claim 14, further configured to enable a driver to pull back on the handle area as the driver applies foot pressure to the pedal to enable correction of the diver's foot action when the driver notices that the driver has inadvertently used too much brake or has stopped in a given situation while traveling on a roadway.
